(19) United States
(12) Patent Application Publication
(10) Pub. No.: US 2014/0071170 A1
(43) Pub. Date: Mar. 13, 2014

(54) NON-UNIFORMLY SCALING A MAP FOR EMPHASIZING AREAS OF INTEREST

(71) Applicant: Nokia Corporation, Espoo (FI)

(72) Inventor: Thomas Kroeber, Berlin (DE)

(21) Appl. No.: 14/116,225

(22) PCT Filed: May 11, 2011
(86) PCT No.: PCT/FI2011/050431

§ 371 Date: Nov. 7, 2013

(51) Int. Cl. G06T 3/40

(52) U.S. Cl. CPC G06T 3/40
USPC 345/660

(57) ABSTRACT

A method, apparatus and computer program where the method comprises determining a plurality of areas of interest where the areas are isolated from each other by intermediate areas; and non-uniformly scaling a map comprising the plurality of areas of interest by changing the relative scaling between the plurality of areas of interest and the intermediate areas.

### TECHNOLOGICAL FIELD

Embodiments of the present invention relate to a method, apparatus and computer program. In particular, they relate to a method, apparatus and computer program for configuring and displaying information such as maps to a user.

### BACKGROUND

Applications such as navigation systems or geo-location systems are known. Such applications enable users to obtain information about their current location or a location of interest. It is useful to configure the obtained information to enable a user to easily extract or access the information they want. Where a large amount of information is available it may be difficult to display all this information to a user in a manner which is easy for a user to find the information relevant for them. This may be particularly problematic for apparatus which have relatively small display screens or in circumstances where a user wishes to view information which is distributed over a large area.

### BRIEF SUMMARY

According to various, but not necessarily all, embodiments of the invention there is provided a method comprising: determining a plurality of areas of interest where the areas are isolated from each other by intermediate areas; non-uniformly scaling a map comprising the plurality of areas of interest by changing the relative scaling between the plurality of areas of interest and the intermediate areas.

In some embodiments of the invention the method may comprise non-uniformly scaling by increasing the relative scaling within the plurality of areas of interest and decreasing the relative scaling between the areas of interest.

In some embodiments of the invention the determining of the areas of interest may comprise determining areas comprising a plurality of points of interest and determining areas with at least a critical density of points of interest.

In some embodiments of the invention the determining of the areas of interest may comprise detecting a user input indicating areas on a map.

In some embodiments of the invention the determining of the areas of interest may comprise analysing metadata of a map.

In some embodiments of the invention the method may further comprise displaying the non-uniformly scaled map on a display. In some embodiments of the invention the areas of interest may be displayed in a tessellated arrangement. The areas of interest may be displayed around a home location. In some embodiments of the invention at least a portion of the intermediate areas might not be displayed on the display.

In some embodiments of the invention the method may further comprise detecting a change in the areas of interest and rescaling the map in response to the detected change. The areas of interest may change in response to a change of one or more points of interest. The areas of interest may change in response to user selection of an area of the map.

In some embodiments of the invention the relative scaling of at least some of the areas between the areas of interest may be decreased to zero so that at least a portion of the intermediate areas may be removed.

According to various, but not necessarily all, embodiments of the invention there may also be provided an apparatus comprising: at least one processor; and at least one memory including computer program code; wherein the at least one memory and the computer program code are configured to, with the at least one processor, enable the apparatus to: determine a plurality of areas of interest where the areas are isolated from each other by intermediate areas; and non-uniformly scale a map comprising the plurality of areas of interest by changing the relative scaling between the plurality of areas of interest and the intermediate areas.

In some embodiments of the invention the non-uniform scaling may comprise increasing the relative scaling within the plurality of interest and decreasing the relative scaling between the areas of interest.

In some embodiments of the invention the determining of the areas of interest may comprise determining areas comprising a plurality of points of interest and determining areas with at least a critical density of points of interest.

In some embodiments of the invention the determining of the areas of interest may comprise detecting a user input indicating areas on a map.

In some embodiments of the invention the determining of the areas of interest may comprise analysing metadata of a map.

In some embodiments of the invention the at least one memory and the computer program code may be further configured to, with the at least one processor, enable a display to display the non-uniformly scaled map. The areas of interest may be displayed in a tessellated arrangement. The areas of interest may be displayed around a home location. In some embodiments of the invention at least a portion of the intermediate areas might not be displayed on the display.

In some embodiments of the invention the at least one memory and the computer program code may be further configured to, with the at least one processor, detect a change in the areas of interest and rescale the map in response to the detected change. The areas of interest may change in response to a change of one or more points of interest. The areas of interest may change in response to user selection of an area of the map.

In some embodiments of the invention the relative scaling of at least some of the areas between the areas of interest may be decreased to zero so that at least a portion of the intermediate areas may be removed.

According to various, but not necessarily all, embodiments of the invention there may also be provided a computer program comprising computer program instructions that, when executed by at least one processor, enable an apparatus at least to perform: determining a plurality of areas of interest where the areas are isolated from each other by intermediate areas; non-uniformly scaling a map comprising the plurality of areas of interest by changing the relative scaling between the plurality of areas of interest and intermediate areas.

In some embodiments of the invention there may be provided a computer program comprising program instructions for causing a computer to perform the methods described above.

In some embodiments of the invention there may be provided a physical entity embodying the computer program as described above.

In some embodiments of the invention there may be provided an electromagnetic carrier signal carrying the computer program as described above.

The apparatus may be for wireless communications.

### BRIEF DESCRIPTION

For a better understanding of various examples of embodiments of the present invention reference will now be made by way of example only to the accompanying drawings in which:

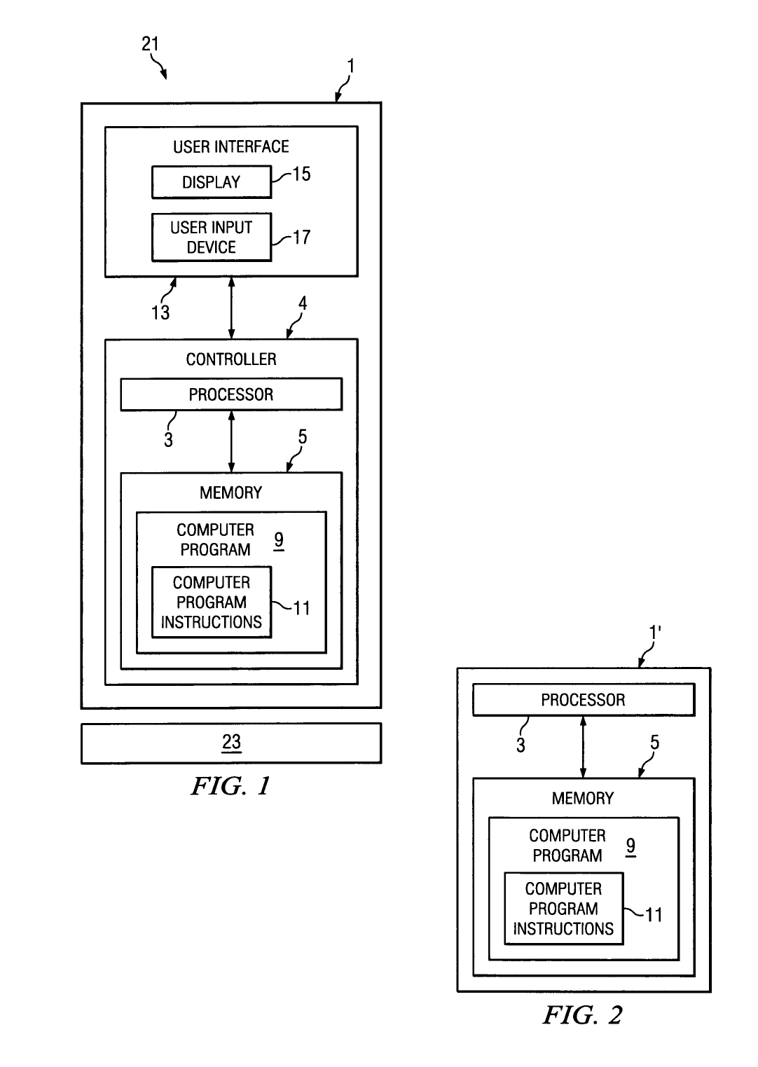

FIG. 1 schematically illustrates an apparatus according to an exemplary embodiment of the invention;

FIG. 2 schematically illustrates an apparatus according to another exemplary embodiment of the invention;

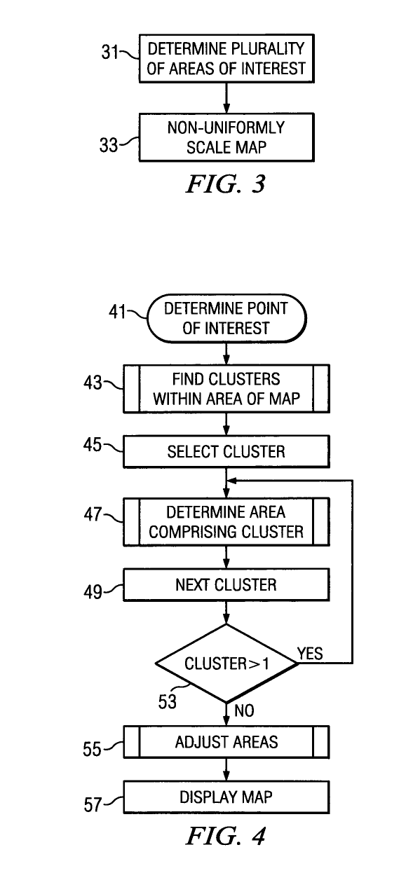

FIG. 3 is a block diagram which schematically illustrates a method according to an exemplary embodiment of the invention;

FIG. 4 is a block diagram which schematically illustrates a method according to another exemplary embodiment of the invention;

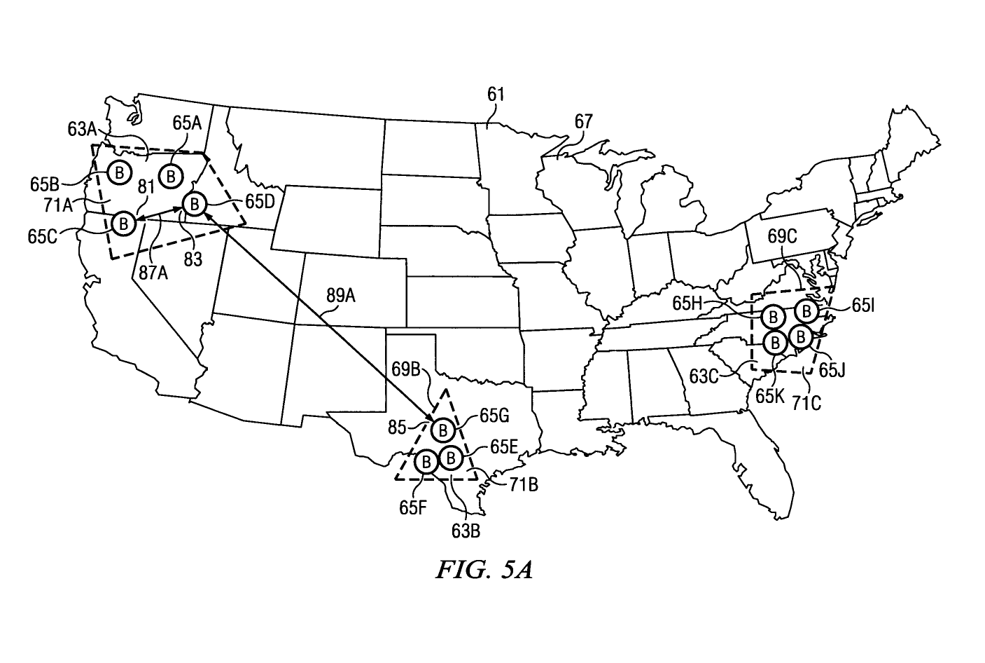

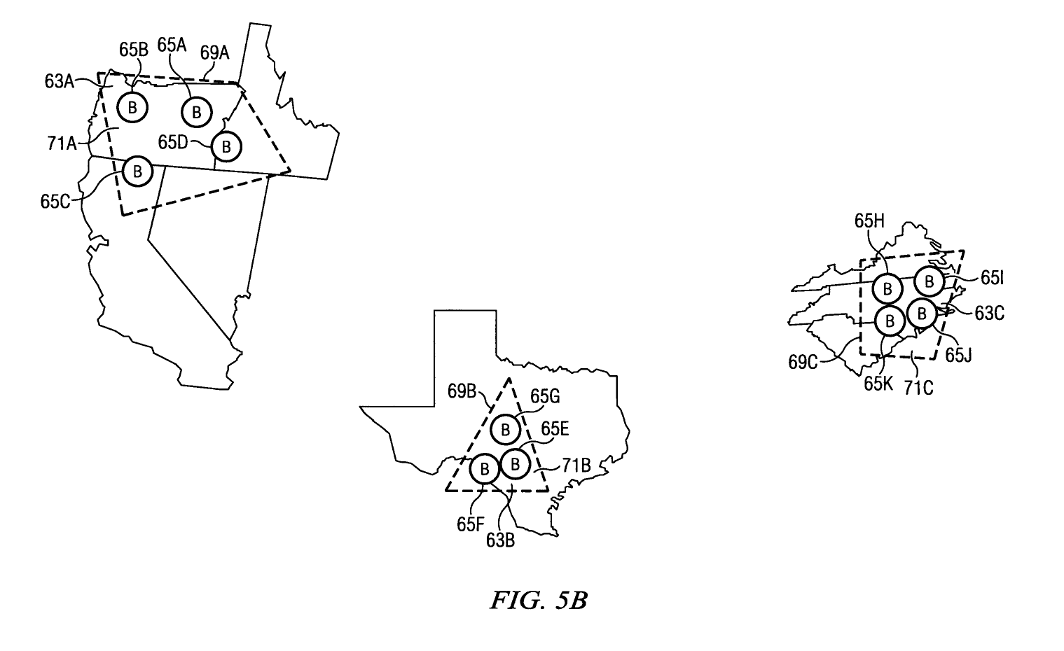

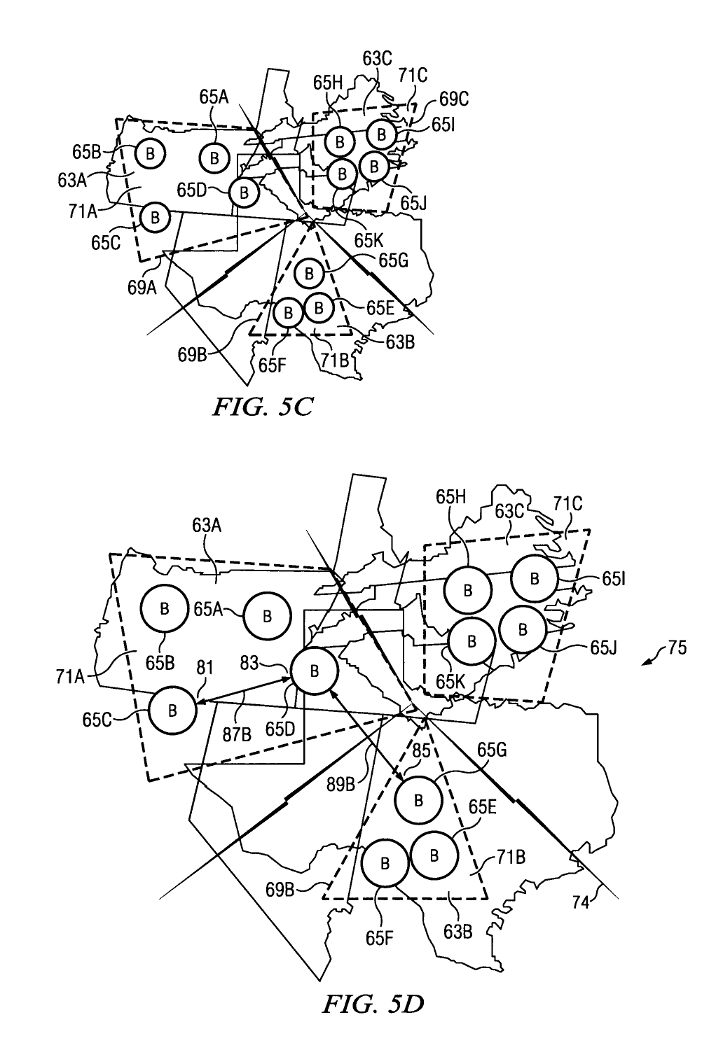

FIGS. 5A to 5D illustrate an exemplary embodiment of the invention; and

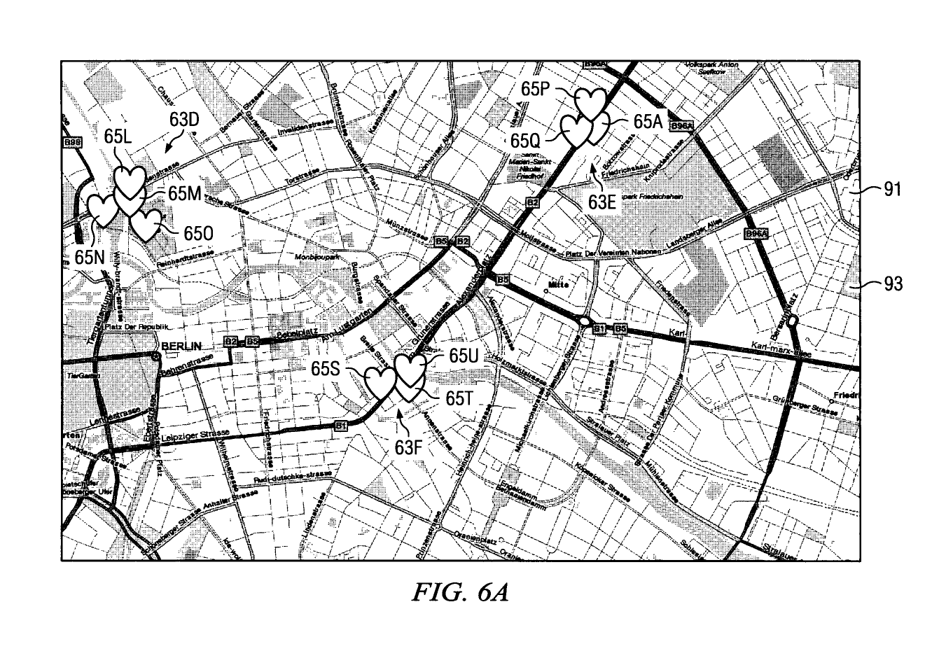

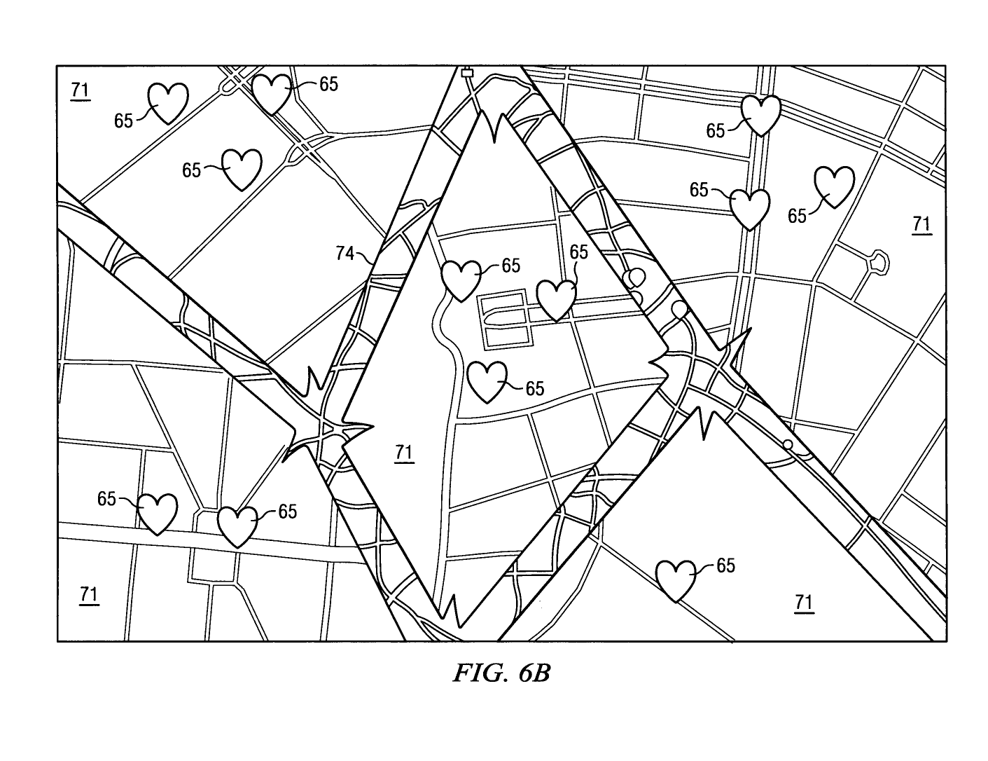

FIGS. 6A and 6B illustrate another exemplary embodiment of the invention

### DETAILED DESCRIPTION

The Figures illustrate embodiments of a method comprising: determining 31 a plurality of areas of interest 71 where the areas 71 are isolated from each other by intermediate areas 67; non-uniformly scaling 33 a map comprising the plurality of areas of interest 71 by changing the relative scaling between the intermediate areas 67 and the areas of interest 71.

FIG. 1 schematically illustrates an apparatus 1 according to an embodiment of the invention. The apparatus 1 may be an electronic apparatus. The apparatus 1 may be, for example, a mobile cellular telephone, a tablet computer, a personal computer, a camera, a gaming device, a personal digital assistant, a personal music player or any other apparatus. In some embodiments of the invention the apparatus 1 may be a handheld apparatus 1 which can be carried in a user's hand, handbag or jacket pocket for example. In other embodiments of the invention the apparatus 1 may be an apparatus such as a desk top or lap top computer.

Only features of the apparatus 1 referred to in the following description are illustrated in FIGS. 1 and 2. However, it should be understood that the apparatus 1 may comprise additional features that are not illustrated. For example, in embodiments where the apparatus 1 is configured to enable communication such as telephone calls or messages the apparatus 1 may also comprise one or more transmitters and receivers.

The exemplary apparatus 1 illustrated in FIG. 1 comprises: a user interface 13 and a controller 4. In the illustrated exemplary embodiment the controller 4 comprises at least one processor 3 and at least one memory 5 and the user interface 13 comprises a display 15 and user input device 17.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc) to be executed by such processors 3.

The at least one processor 3 is configured to receive input commands from the user interface 13 and also to provide output commands to the user interface 13. The at least one processor 3 is also configured to write to and read from the at least one memory 5. Outputs of the user interface 13 are provided as inputs to the controller 4.

The user interface 13 may comprise any means which enables a user to interact with and control the apparatus 1.

The display 15 may comprise any means which enables information to be displayed to a user of the apparatus 1. The information may correspond to information which has been input by the user via the user input device 17, information which is stored in the one or more memories 5 or information which has been received by apparatus 1.

The display 15 may be configured to display graphical user interfaces 75 as illustrated in FIGS. 5D and 6B.

The user input device 17 may comprise any means which enable a user of the apparatus 1 to input information into the apparatus 1. The input information may be used to control the apparatus 1 or may be stored in the one or more memories 5 of the apparatus 1. In exemplary embodiments of the invention the user input device 17 may comprise a keypad or a portion of a touch sensitive display or a combination of a number of different types of user input devices.

The at least one memory 5 may be configured to store a computer program code 9 comprising computer program instructions 11 that control the operation of the apparatus 1 when loaded into the at least one processor 3. The computer program instructions 11 provide the logic and routines that enable the apparatus 1 to perform the methods illustrated in FIGS. 3 and 4 and described below. The at least one processor 3 by reading the at least one memory 5 is able to load and execute the computer program code 9.

The computer program instructions 11 may provide computer readable program means configured to control the apparatus 1. The program instructions 11 may provide, when loaded into the controller 4; means for determining 31 a plurality of areas of interest 71 where the areas are isolated from each other by intermediate areas 67; and means for non-uniformly scaling 33 a map comprising the plurality of areas of interest 71 by changing the relative scaling between the plurality of areas of interest and the intermediate areas 67.

The computer program code 9 may arrive at the apparatus 1 via any suitable delivery mechanism 21. The delivery mechanism 21 may be, for example, a computer-readable storage medium, a computer program product 23, a memory device, a record medium such as a CD-ROM or DVD or an article of manufacture that tangibly embodies the computer program code 9. The delivery mechanism may be a signal configured to reliably transfer the computer program code 9. The apparatus 1 may propagate or transmit the computer program code 9 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific integration circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 2 illustrates an apparatus 1′ according to another embodiment of the invention. The apparatus 1′ illustrated in FIG. 2 may be a chip or a chip-set. The apparatus 1′ comprises at least one processor 3 and at least one memory 5 as described above in relation to FIG. 1.

FIGS. 3 and 4 illustrate methods according to exemplary embodiments of the invention.

FIG. 3 illustrates a method which enables information to be provided to a user of the apparatus 1 in a manner which is convenient for a user. At block 31 a plurality of areas of interest 71 are determined. The plurality of areas of interest 71 may be determined using any suitable method. The processor 3 may determine the plurality of areas of interest. In some embodiments of the invention the plurality of areas of interest 71 may be determined by a remote apparatus and provided to the apparatus 1 via a communication means.

The plurality of areas of interest 71 may correspond to areas of a map 61, 91. In some embodiments of the invention the plurality of areas of interest 71 may be located within a predetermined distance of a home location on the map. The home location could be, for example, the current location of the user of the apparatus 1 or a location which the user has entered into the apparatus 1 using the user input device 17.

In some embodiments of the invention determining 31 the plurality of areas of interest 71 may comprise determining a plurality of points of interest 65 and then determining any areas which comprise a cluster 63 of points of interest 65.

The points of interest 65 may comprise any location on a map 61, 91 which may be of specific interest or use to a user of the apparatus 1. In some embodiments of the invention the user may be able to indicate the points of interest that they would like to obtain information for. For example, a user may use a search engine to find business or services within a particular area. In such examples, the points of interest 65 may correspond to the businesses or services which are found as results of such a search.

In some embodiments of the invention the points of interest 65 may comprise locations which are associated with the user of the apparatus 1 or with information stored in the one or more memories 5 of the apparatus 1. For example, the apparatus 1 may be configured to provide a contacts application which enables a user to store contact details of other users of other apparatus. The contact details may be stored in a contact list and may include location information. The location information could comprise an address at which the contact lives or works or a current or recent location of the contact. This location could then be used to determine the points of interest 65.

In other embodiments of the invention the apparatus 1 may be configured to provide a calendar application which may enable a user to schedule events. The scheduled events may be associated with locations which could then be used to determine the points of interest 65.

Once the points of interest 65 have been determined the processor 3 may determine whether or not any areas comprise a cluster 63 of points of interest 65. A cluster 63 of points of interest 65 may be any area where a plurality of points of interest 65 are close enough together to exceed a critical density of point of interest 65. The area of interest 71 may comprise an area containing at least the cluster 63 of points of interest 65. The area of interest 71 may be any suitable shape such as a circle or a regular polygon or an irregular polygon. Different shapes may be used in different embodiments of the invention.

In other embodiments of the invention the determining of the areas of interest may comprise analyzing metadata associated with a map 61, 91. In such embodiments of the invention the apparatus 1 may be configured to access map information. The map information may be stored in the one or more memories 5 or the apparatus 1 may or the apparatus 1 may be configured to retrieve the map information from an external source such as a remote server.

The map information may comprise a plurality of levels of information. A first level of information may include information relating to the landscape of an area. The landscape of the area may comprise the natural features of an area such as the relief of the land and features such as seas or lakes and rivers.

A second level of information may comprise information relating to the infrastructure or buildings of an area. This information may include information relating to the location of transport networks such as roads and railways and also the locations of towns and cities. The information may also include the location of specific buildings or places within the towns and cities.

A further level of information may comprise metadata relating to the landscape or infrastructure or buildings. The metadata may comprise labels identifying features of the landscape or infrastructure or buildings. For example, the metadata may include the names of towns or cities and the streets and buildings within them or the names of the areas within the map. The metadata may also include information categorizing items on the map. For example, locations which provide particular services may all be identified as being in a particular category. Similarly the areas of the landscape may also be categorized. This may enable the processor 3 to distinguish between areas of land and areas of sea, for example.

The processor 3 may be configured to analyze the metadata of the map information to determine areas of interest. For example, the user of the apparatus may have indicated an interest in certain types of items on a map. The processor 3 may search the metadata to find areas of the map comprising corresponding items.

Conversely, in some embodiments of the invention the user might indicate that they are not interested in particular areas of the map and do not want information relating to particular areas. For example the user might not want to see areas which are unlikely to contain places they would like to go, such as the sea or areas which do not contain any towns or cities. In such embodiments of the invention the processor 3 may determine the areas of interest by analyzing the metadata and finding areas which do not contain items the user is not interested in and excluding these areas from the map.

In some embodiments of the invention the areas of interest may be determined in response to a user input indicating areas of a map 61, 91. In such embodiments of the invention a map 61, 91 may be displayed on the display 15. The user may then use the user input device 17 to indicate specific areas of the map 61, 91. For example, in embodiments where the display 15 is a touch sensitive display the user may be able to indicate specific areas of a map by touching the respective area of the display 15 in which the areas of the map 61, 91 are displayed. The user may be able to select areas that they are interested in. Alternatively the user may make a user input identifying areas that they are not interested in.

The apparatus 1 may be configured to enable a user to select any number of areas.

At block 33 a map comprising the plurality of areas of interest is scaled non-uniformly. The processor 3 may perform the non-uniform scaling 33.

The non-uniform scaling changes the relative scaling between the areas of interest 71 and the intermediate areas 67. In some embodiments of the invention the non-uniform scaling is such that the relative scaling within the areas of interest 71 is increased and the relative scaling between the areas of interest 71 is decreased.

Examples of non-uniform scaling according to embodiments of the invention are illustrated in FIGS. 5D and 6B.

This non-uniform scaling enables the areas of interest 71 to be displayed at a larger scale to enable the user to obtain the information relating to the areas of interest 71 more easily. In some embodiments of the invention this may make it easier for the user to control the apparatus 1. For example, the areas of interest may comprise user selectable items and by increasing the relative distance between the user selectable items it may make it easier for the user to select the items and decrease the likelihood of the user selecting an incorrect item.

The decrease in scaling between the areas of interest 71 may reduce the total amount of information which is provided to the user. This makes it easier for a user to obtain the information they want as they are not provided with information which is not relevant to them.

The decrease in scaling between the areas of interest may also enable the plurality of areas of interest to be displayed simultaneously at a relatively large scale as the relative distance between the different areas of interest may be decreased. This enables a user to access the information relevant to them without having to scroll through a map 61, 91 or manually zoom in and out of the map 61, 91. This may make the information easier for a user to obtain as it reduces the amount of user inputs necessary to enable the user to view all the information they want.

Once the non-uniform scaling 33 has been performed the processor 3 may configure the apparatus 1 to enable the non-uniformly scaled map 61, 91 to be displayed on the display 15.

FIG. 4 illustrates a method according to an embodiment of the invention in more detail. In the embodiment illustrated in FIG. 4 the areas of interest 71 are determined by determining areas containing a cluster 63 of points of interest 65.

At block 41 the points of interest 65 are determined. As mentioned above the points of interest 65 may be any locations on a map 61, 91 or area which a user has indicated a specific interest in. As described above they might be the locations of places or services the user had searched for or locations associated with a contact or calendar application.

At block 43 the processor determines whether or not there are any clusters 63 of points of interest 65 within the area or map 61, 91. The clusters 63 of the points of interest 65 may be any group of points of interest 65 which are close enough together so that the density of the points of interest 65 is above a critical density. In some embodiments of the invention the critical density could be a single point of interest.

The critical density may depend on a number of factors. For example, the critical density may depend on the total number of points of interest which have been found or the total area which has been searched or the size of the display available 15 or any other factor. In some embodiments of the invention the critical density could be user defined. For example a user may indicate the number of points of interest they would like in each cluster. In other embodiments of the invention the critical density may be indirectly user defined. For example, a user may indicate the minimum or maximum scale of the map they would prefer and this may determine the critical density.

The processor 3 may be configured to identify clusters 63 within a given region. The region may be centered around a home location. The home location could be the current location of the user of the apparatus 1. If the user is mobile then the home location and the corresponding clusters may change as the location of the user changes. The current location may be determined using geo-location techniques or may be entered into the apparatus 1 manually by the user using the user input device 17. In other embodiments of the invention the home location may be any location which has been specified by the user of the apparatus 1. For example, it could be a place or location which they are intending to visit. The processor 3 may identify clusters 63 within a predetermined distance from the home location.

In the embodiments of the invention the processor 3 finds a plurality of clusters 63 of points of interest 65. The clusters 63 of points of interest 65 are isolated from each other by intermediate regions 67. In some embodiments of the invention the intermediate regions 67 might not contain any points of interest 65.

At block 45 the processor 3 selects one of the clusters and at block 47 the processor determines an area comprising the selected cluster 63. The area comprising the selected cluster 63 is one of the plurality of areas of interest 71.

In the embodiment illustrated in FIG. 4 the area may be determined by computing a convex hull of a polygon comprising all of the points of interest 65 within the cluster 63. The convex hull of the polygon is the smallest area convex polygon which encloses all of the points of interest 65. The convex hull may be determined using any suitable technique. It is to be appreciated that in other embodiments of the invention other shapes or areas may be determined.

At block 49 the processor 3 determines whether or not there are any other remaining clusters 63 which have not yet been analyzed to find a corresponding area of interest 71.

If there is another cluster 63 to be analyzed then at block 51 the process returns to block 47 and determines an area comprising the points of interest for the next cluster 63. Blocks 47, 49 and 51 may be repeated until all of the clusters 63 of points of interest 65 have been analyzed.

Once all of the clusters 63 have been analyzed, then at block 51 the process proceeds to block 53 and the shapes of the determined areas are adjusted. The shapes of the areas are adjusted to enable the plurality of areas to be fitted together so that they may be displayed simultaneously on the display 15. The shapes of the areas may depend on a number of factors such as the shapes which were determined at block 47, the number of clusters 63 and corresponding areas which have been analyzed and the shape of the display 15 which is to be used to display the information.

The shapes may be adjusted to enable the areas of interest 71 to be displayed in a tessellated arrangement. The tessellated arrangement may enable the areas of interest 71 to be displayed in a plane with minimal gaps between the respective areas of interest 71 and no overlap of the areas 71.

In some embodiments of the invention the shapes of the areas of interest 71 may be adjusted to fit around the home location. The relative positions of the respective areas of interest 71 may be generally maintained so that if a first cluster 63 is located to the North of a home location and a second cluster 63 is located to the West, then the shapes of the corresponding areas of interest 71 may be adjusted to enable them to be displayed in positions which are generally to the North and West of the home location respectively. This may enable a user to obtain a general indication of the relative positions of the point of interest without having to zoom in and out of a map 61, 91.

The adjustment of the shapes of the areas of interest 71 may comprise non-uniform rescaling of the map 61, 91 comprising the areas of interest 71. The scale of the areas of the map 61, 91 within the areas of interest 71 may be increased to increase the relative distance between two points within the same area of interest. The scale of the areas of the map 61, 91 which are not within the areas of interest 71 may be decreased to decrease the relative distance between two points which are in different areas of interest 71.

Once the determined areas have been adjusted then, at block 55 the adjusted areas are displayed on the display 15. In some embodiments of the invention the non-uniformly scaled map 61, 91 may replace a standard uniformly scaled map 61, 91 on the display 15. For example, a user could access a map 61, 91 application and then search for points of interest. A standard uniformly scaled map 61, 91 showing the points of interest 65 could then be displayed on the display 15. FIGS. 5A and 6A illustrate examples of uniformly scaled maps 61, 91 which might be displayed on a display 15. The user may make a user input indicating that they wish to view the areas around the points of interest 65 in more detail. The user may make such an indication by selecting a user selectable item or actuating a particular portion of the user input device 17. In embodiments of the invention where the display 15 is a touch sensitive display the user may make the indication by making a particular type of input on the display 15 such as a double tap input. In response to the user input the processor 3 may then carry out the methods described above and control the display 16 to replace the uniformly scaled map 61, 91 with a non-uniformly scaled map as illustrated in FIGS. 5D and 6B. The user may control the apparatus 1 to return to the original uniformly scaled map 61, 91 by making a further user input.

In other embodiments of the invention the non-uniformly scaled map may be provided as a home page. For example the non-uniformly scaled map may be provided automatically whenever a user accesses a particular application such as a contact or calendar application.

FIGS. 5A to 5D illustrate an exemplary embodiment of the invention. In this exemplary embodiment of the invention the user may be searching for a contact, for example. The user may be searching for a contact by using the user input device 17 to input a name into a search field of a search engine. In the particular embodiment of FIGS. 5A to 5D the user has input the letter B.

FIG. 5A illustrates a uniformly scaled map 61 of the United States of America. The user of the apparatus 1 may be located in the United States of America or may have selected the United States of America using the user input device 17.

In some embodiments of the invention the map 61 may be displayed on the display 15. In other embodiments of the invention the map 61 might not actually be displayed on the display 15 but the information provided within the map 61 is accessible by the processor 3.

The map of FIG. 5A is scaled uniformly so that the ratio of distance between two points as displayed on the map and two points in the real location corresponding to the map would be the same for any two points on the map.

For example the distance between points 81 and 83 is indicated by the line 87A in FIG. 5A and the distance between points 83 and 85 is indicated by line 89A. Points 81 and 83 are located within the same area of interest 71 and points 83 and 85 are located within different areas of interest 71. The ratio of the distance 87A as would be displayed on a display 15 and the distance in the real world is the same as the distance 89B as would be displayed on a display 15 and the corresponding distance in the real world.

The map 61 comprises a plurality of clusters 63A to C of points of interest 65A to K. Each point of interest 65A to K comprises the letter B. This indicates that the user has input the letter B into the search field. The points of interest 65A to K may represent the location of contacts within a contact list whose name begins with or contains the letter B.

In the exemplary map illustrated in FIG. 5A the first cluster 63A comprises four points of interest 65A to 65D and is located towards the North West of the map. The second cluster 63B comprises three points of interest 65E to 65G and is located towards the South of the map. The third cluster 63C comprises three points of interest 65H to 65K and is located towards the East of the map. The three clusters 63 are isolated from each other by an intermediate area 67. In the particular example of FIG. 5A there are no points of interest located within the intermediate area 67.

In the map 61 illustrated in FIG. 5A the processor 3 has performed blocks 43 and 47 of the method of FIG. 4. The processor 3 has found clusters 63 within the map 61 and has determined the areas of interest 71 which comprise the clusters 63. The dashed lines 69A to 69C in FIG. 5A indicate the respective determined areas of interest 71A to 71C. In the embodiment illustrated in FIG. 5A each of the areas of interest 71A to 71C is a convex polygon. It is to be appreciated that other shapes could be used in other embodiments of the invention.

In FIG. 5B the processor 3 has removed the intermediate areas 67 from the map. The processor 3 may remove any areas which do not contain an area of interest 71. In some embodiments of the invention the processor 3 may remove any areas which do not contain a point of interest 65. In FIG. 5B only the areas of interest 63A to C and a small area of the map around the areas of interest 63A to C are not removed.

The intermediate areas 67 are removed so that they are no longer displayed on the display 15. The removed information may still be stored in the one or more memories 5 of the apparatus 1 or may still be accessed by the apparatus 1. This enables the information which is not relevant to be hidden from the user and reduce the total amount of information provided to the user.

In FIG. 5C the processor 3 adjusts the shapes of the areas of interest 71A to C to enable them to fit together. In the embodiment illustrated in FIG. 5C the areas of interest 71A to C are fitted together around a central point. The relative positions of the areas of interest 71A to C are maintained so that the first area of interest 71A is positioned towards the top left of the central point, the second area of interest 71B is positioned below the central point and the third point of interest 71C is positioned to the right of the central location.

In order to enable the areas of interest 71A to C to be fitted together some additional areas of the map is padded around the respective polygon indicated by the dashed lines 69. This may change the shape of the areas of interest 71. It is to be appreciated that in some embodiments of the invention some of the area within the dashed lines 69 may be removed to change the shape of the areas of interest 71.

FIG. 5D illustrates a graphical user interface 75 which may be displayed on the display 15 once the non-uniform rescaling has been completed. The graphical user interface 75 comprises the areas of interest 63A to 63C which are fitted together as illustrated in FIG. 5C. The areas of interest 63A to 63C are resized to fill the space available on the display 15.

In the embodiment illustrated in FIG. 5D a boundary 74 is indicated between the determined areas to indicate that the intermediate portion 67 has been removed and the map is not a continuous uniformly scaled map. This enables a user to clearly identify that some information has been hidden from the display. In some embodiments of the invention the user may be able to make a user input to retrieve such information.

The map in FIG. 5D has been non-uniformly rescaled. The relative scaling within the areas of interest 71A to 71C has been increased and the relative scaling between the areas of interest 71A to 71C has been decreased.

In the map 61 of FIG. 5D the ratio of distance between two points as displayed on the display 15 and two points in the real world location corresponding to the map is not the same for any two points on the map.

The distance between points 81 and 83 is indicated by the line 87B in FIG. 5D. This distance has increased with respect to the distance as displayed in FIG. 5A because the scaling within the area of interest 71A has increased. The distance between points 83 and 85 is indicated by line 89B in FIG. 5D. This distance has decreased with respect to the distance as displayed in FIG. 5A because the intermediate area 67 has been removed to decrease the scaling between areas of interest 71. Therefore scaling of the map illustrated in FIG. 5D has increased relative scaling within the areas of interest 71 and decreased relative scaling between the areas of interest 71.

In some embodiments of the invention the points of interest 65A to 65K may comprise user selectable items on the display 15. The points of interest 65A to 65K may enable a user to access further information or content associated with the respective locations on the map 61. Therefore the points of interest 65A to 65K may provide control elements which enable a user to control the apparatus 1 and interact with the map. In such embodiments of the invention it may be particularly advantageous to increase the distance between the point of interest 65 on the display 15 as this will make it easier for the user to select the correct point of interest 65.

FIGS. 6A to 5B illustrate another exemplary embodiment of the invention.

FIG. 6A illustrates a map 91 of Berlin. The map of Berlin may be centered around a location. The location may be the home location of the user of the apparatus 1. Alternatively the central location could be a reference point which has been indicated by a user such as a location which they are intending to visit or any other purpose.

The map 91 comprises a plurality of clusters 63D, E, F of points of interest 65L to U. In the exemplary map 91 illustrated in FIG. 6A the first cluster 63D comprises four points of interest 65L to 65O and is located towards to the North West of the map 91. The second cluster 63E comprises three points of interest 65E to 65G and is located toward the North East of the map 91. The third cluster 63F comprises three points of interest 65S to 65U and is located substantially in the centre of the map 91. The three clusters are isolated from each other by an intermediate area 93. In the particular example of FIG. 6A there are no points of interest located within the intermediate area 93.

In the map illustrated in FIG. 6A the points of interest 65 are so close together that the items indicating the points of interest 65 on the display 15 are overlapping each other. This may make it difficult for a user to distinguish between the respective points of interest 65. Also where the points of interest 65 comprise user selectable items it may be difficult for the user to identify and select the correct items.

FIG. 6B illustrates an exemplary graphical user interface 75 which may be displayed on the display 15 after the methods illustrated in FIGS. 3 and 4 have been performed on a map such as the one illustrated in FIG. 6A. In FIG. 6B a map 91 has been non-uniformly rescaled to increase the relative distance between points of interest 65 within a given cluster 63 but decrease the relative distance between the clusters 63 themselves.

In the graphical user interface 75 of FIG. 6B the points of interest 65 are displayed within areas of interest 71. The scaling within the areas of interest 71 has been increased so that the points of interest 65 are well separated from each on the display 15. The user can now easily distinguish between the points of interest 65. The scaling between the areas of interest 71 has been decreased so that the areas of interest are displayed adjacent each other on the display 15 with only the boundary 74 separating them. The intermediate areas 93 of the map 91 have been removed so that only a small portion of this area remains on the display 15.

The graphical user interface illustrated in FIG. 6B comprises a boundary 74. The boundary 74 indicates that there are areas of the map 91 which are not currently displayed on the display 15 or which are displayed at a much smaller scale than the areas of interest 71. In the embodiment of the invention illustrated in FIG. 6B the boundary is configured to look as though the map has been folded. This may be an intuitive way of indicating the boundary 74 as it clearly represents that more information is available but it also replicates the real word task of folding a map.

The user may control the apparatus 1 to change the areas of interest 71. For example, in embodiments of the invention where the display 15 is a touch sensitive display the user may be able to make a trace or pinch input to control the scaling of the map 61.

A user may make a pinch input by touching the display 15 with their thumb in a first portion where a first area of interest 71 is displayed and touching the display 15 with a finger in a second portion where a second area of interest 71 is displayed. If the user brings their finger and thumb closer together then this would decrease the scaling of the areas between the areas of interest 71 and bring the areas of interest closer together on the display 15. The scaling within the areas of interest 71 would be increased correspondingly. Some of the areas of the map currently displayed on the display 15 may be removed in response to the user input.

Conversely, if the user brings their finger and thumb further apart then this could increase the scaling of the areas between the areas of interest 71 so that the respective areas of interest 71 are displayed further apart on the display 15. The scaling within the areas of interest 71 could be decreased correspondingly to enable them to be displayed on the display 15 simultaneously.

The areas of interest may also change in response to a detected change in the points of interest. For example a user may have initially searched for a first type of business or service and may then refine that search or search for different business or services. The processor may then repeat the methods described above with the new points of interest found by the new search.

Embodiments of the invention provide a method and apparatus which enable the most relevant information to be displayed to a user and the less relevant information to be hidden. This may make the apparatus easier for a user to use as it may decrease the number of user inputs necessary to obtain and view relevant information.

Embodiments of the invention also reduce the number of user inputs which the user may have to make as the rescaling may be carried out automatically. For example the apparatus may automatically determine that the size of the display or the distribution of the points of interest are such that the points of interest cannot all be simultaneously displayed on a uniformly scaled map unless the scale of the map is reduced to a very small level. The very small level may make it difficult for a user to distinguish between the points of interest. In response to such a determination the exemplary processes of non-uniformly scaling a map, as described above in relation to FIGS. 3 and 4 may be performed by the apparatus without any user input. In some alternative embodiments of the invention the user may control the apparatus to select the non-uniform scaling of the map, for example the user may select an option from a menu or make a particular type of user input via the user input device. Once the user has selected the option the process of non-uniformly scaling the map may be performed without any further user input.

This means that the user can view all the points of interest at an appropriate scale without having to zoom in and out of the map. This may also reduce the need for the user to browse or scroll through a map to find information which they are looking for.

The blocks illustrated in the Figs and 4 may represent steps in a method and/or sections of code in the computer program code 9. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example, in some embodiments of the invention the scaling of at least some of the areas between the areas of interest is decreased to zero may be decreased to zero so that at least some of the intermediate areas are removed. In some embodiments of the invention the intermediate areas may be removed completely so that when the non-uniformly scaled map is displayed on the display only the areas of interest are displayed. In some embodiments of the invention there may be a gap or boundary displayed between the respective areas of interest to indicate that the intermediate areas of the map have been removed. This may enable the context of the respective areas to be easily determined by the user of the apparatus.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-30. (canceled)

31. A method comprising:
determining a plurality of areas of interest where the areas are isolated from each other by intermediate areas;
non-uniformly scaling a map comprising the plurality of areas of interest by changing the relative scaling between the plurality of areas of interest and the intermediate areas.

32. A method of claim 31 wherein the non-uniformly scaling comprises increasing the relative scaling within the plurality of areas of interest and decreasing the relative scaling between the areas of interest.

33. A method of claim 31, wherein the determining of the areas of interest comprises determining areas comprising a plurality of points of interest and determining areas with at least a critical density of points of interest.

34. A method of claim 31, wherein the determining of the areas of interest comprises detecting a user input indicating areas on a map.

35. A method of claim 31, wherein the determining of the areas of interest comprises analysing metadata of a map.

36. A method of claim 31, further comprising displaying the non-uniformly scaled map on a display.

37. A method of claim 36 wherein the areas of interest are displayed in a tessellated arrangement.

38. A method of claim 36, wherein at least a portion of the intermediate areas are not displayed on the display.

39. A method of claims 31, further comprising detecting a change in the areas of interest and rescaling the map in response to the detected change.

40. A method of claim 31, wherein the relative scaling of at least some of the areas between the areas of interest is decreased to zero so that at least a portion of the intermediate areas is removed.

41. An apparatus comprising:
at least one processor; and
at least one memory including computer program code;
wherein the at least one memory and the computer program code are configured to, with the at least one processor, enable the apparatus to:
determine a plurality of areas of interest where the areas are isolated from each other by intermediate areas; and
non-uniformly scale a map comprising the plurality of areas of interest by changing the relative scaling between the plurality of areas of interest and the intermediate areas.

42. An apparatus of claim 41, wherein the non-uniformly scaling comprises increasing the relative scaling within the plurality of areas of interest and decreasing the relative scaling between the areas of interest.

43. An apparatus of claim 41, wherein the determining of the areas of interest comprises determining areas comprising a plurality of points of interest and determining areas with at least a critical density of points of interest.

44. An apparatus of claim 41, wherein the determining of the areas of interest comprises detecting a user input indicating areas on a map.

45. An apparatus of claim 41, wherein the determining of the areas of interest comprises analysing metadata of a map.

46. An apparatus of claim 41, wherein the at least one memory and the computer program code are further configured to, with the at least one processor, enable a display to display the non-uniformly scaled map.

47. An apparatus of claim 46, wherein the areas of interest are displayed in a tessellated arrangement.

48. An apparatus of claim 46, wherein at least a portion of the intermediate areas are not displayed on the display.

49. An apparatus of claim 41, wherein the at least one memory and the computer program code are further configured to, with the at least one processor, detect a change in the areas of interest and rescale the map in response to the detected change.

50. An apparatus of claim 41, wherein the relative scaling of at least some of the areas between the areas of interest is decreased to zero so that at least a portion of the intermediate areas is removed.

51. A computer program comprising computer program instructions that, when executed by at least one processor, enable an apparatus at least to perform:
determining a plurality of areas of interest where the areas are isolated from each other by intermediate areas;
non-uniformly scaling a map comprising the plurality of areas of interest by changing the relative scaling between the plurality of areas of interest and the intermediate areas.
